(19) United States
(12) Patent Application Publication
(10) Pub. No.: US 2025/0159581 A1
(43) Pub. Date: May 15, 2025

(54) AMBIENT INTERNET OF THINGS (IOT) DEVICE INTEGRATION

(71) Applicant: Lenovo (Singapore) Pte Limited, Singapore (SG)

(72) Inventors: Andreas KUNZ, Ladenburg (DE); Sheeba Backia Mary BASKARAN, Friedrichsdorf (DE)

(21) Appl. No.: 18/942,033

(22) Filed: Nov. 8, 2024

Related U.S. Application Data
(60) Provisional application No. 63/597,849, filed on Nov. 10, 2023.

(51) Int. Cl. H04W 40/02; H04W 76/10; H04W 84/12

(52) U.S. Cl. CPC H04W 40/02; H04W 76/10; H04W 84/12

(57) ABSTRACT

Various aspects of the present disclosure relate to providing a network gateway, or gateway device, which can be utilized to integrate and interwork different types of IoT devices with an IoT Server or Application Function. The network gateway may be configured to manage the traffic between the IoT devices device and the IoT Server/Application by providing a secure connection and mapping via the gateway.

### CROSS REFERENCE TO RELATED APPLICATIONS

This application claims priority to U.S. Provisional Patent Application No. 63/597,849, filed on Nov. 10, 2023, entitled AMBIENT INTERNET OF THINGS (IOT) DEVICE INTEGRATION, which is incorporated by reference in its entirety.

### TECHNICAL FIELD

The present disclosure relates to wireless communications, and more specifically to integrating Internet of Things (IoT) devices to a network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support integrating and/or managing ambient IoT devices with a network, such as a network that supports 5G radio access technology.

Some implementations of the method and apparatuses described herein may further include a network gateway, comprising a processor and a memory coupled with the processor, the processor configured to cause the network gateway to receive, from a first network function, User Equipment Route Selection Policy (URSP) rules for internet of things (IoT) device types associated with IoT devices, wherein the URSP rules configure the network gateway to map data traffic from the IoT devices to an established protocol data unit (PDU) session with a second network function and map the data traffic between the IoT devices to a secure user plane session to the second network function based on the URSP rules for the IoT device types of the IoT devices.

In some implementations of the method and apparatuses described herein, the first network function is a Policy Control Function (PCF) and the second network function is an IoT Server or Application Function (AF).

In some implementations of the method and apparatuses described herein, the processor is further configured to cause the network gateway to send, to a third network function, a registration request that indicates capabilities of IoT device types supported by the network gateway.

In some implementations of the method and apparatuses described herein, the third network function is an Access and Mobility Management Function (AMF).

In some implementations of the method and apparatuses described herein, the capabilities of IoT device types indicated by the registration request include whether an IoT device includes a universal subscriber identity module (USIM) or whether an IoT device includes Non Access Stratum (NAS) support.

In some implementations of the method and apparatuses described herein, the processor is further configured to cause the network gateway to establish the secure user plane session over the established PDU Session with the second network function.

In some implementations of the method and apparatuses described herein, the processor is further configured to cause the network gateway to receive configuration messages from the second network function over the secure user plane connection.

In some implementations of the method and apparatuses described herein, the processor is further configured to cause the network gateway to authenticate the IoT devices via a fourth network function and register the IoT devices at the second network function after a successful authentication.

In some implementations of the method and apparatuses described herein, the fourth network function is an Authentication Server Function (AUSF).

In some implementations of the method and apparatuses described herein, the network gateway acts as a Trusted WLAN Interworking Function (TWIF) for a first subset of IoT devices, a WLAN access node (AN) for a second subset of IoT devices, a Wireline Access Gateway Function (W-AGF) for a third subset of IoT devices, and a gateway with interworking capabilities for a fourth subset of IoT devices.

Some implementations of the method and apparatuses described herein may further include a method performed by a network gateway, the method comprising receiving, from a first network function, URSP rules for IoT device types associated with IoT devices, wherein the URSP rules configure the network gateway to map data traffic from the IoT devices to a PDU session with a second network function, and mapping the data traffic between the IoT devices to a secure user plane session to the second network function based on the URSP rules for the IoT device types of the IoT devices.

In some implementations of the method and apparatuses described herein, the first network function is a PCF and the second network function is an IoT Server or AF.

In some implementations of the method and apparatuses described herein, the method further includes sending, to a third network function, a registration request that indicates capabilities of IoT device types supported by the network gateway.

In some implementations of the method and apparatuses described herein, the third network function is an AMF.

In some implementations of the method and apparatuses described herein, the capabilities of IoT device types indicated by the registration request include whether an IoT device includes a USIM or whether an IoT device includes NAS support.

In some implementations of the method and apparatuses described herein, the method further includes establishing the secure user plane session over the established PDU Session with the second network function.

In some implementations of the method and apparatuses described herein, the method further includes receiving configuration messages from the second network function over the secure user plane connection.

In some implementations of the method and apparatuses described herein, the method further includes authenticating the IoT devices via a fourth network function and registering the IoT devices at the second network function after a successful authentication.

In some implementations of the method and apparatuses described herein, the fourth network function is an AUSF.

In some implementations of the method and apparatuses described herein, the network gateway acts as a TWIF for a first subset of IoT devices, a WLAN access node for a second subset of IoT devices, a W-AGF for a third subset of IoT devices, and a gateway with interworking capabilities for a fourth subset of IoT devices.

Some implementations of the method and apparatuses described herein may further include a network gateway, comprising a processor and a memory coupled with the processor, the processor configured to cause the network gateway to receive a configuration that maps data traffic from local IoT devices to an established PDU session with an IoT Server and map the data traffic between the local IoT devices to a secure user plane session to the IoT Server based on the configuration.

In some implementations of the method and apparatuses described herein, the configuration includes URSP rules for IoT device types associated with the local IoT devices.

In some implementations of the method and apparatuses described herein, the network gateway receives the configuration from a PCF.

In some implementations of the method and apparatuses described herein, the local IoT devices are ambient IoT devices, and wherein the network gateway is an IoT Gateway via which the ambient IoT devices access a 5G network.

Some implementations of the method and apparatuses described herein may further include a method performed by a network gateway, the method comprising receiving a configuration that maps data traffic from local IoT devices to an established PDU session with an IoT Server and mapping the data traffic between the local IoT devices to a secure user plane session to the IoT Server based on the configuration.

In some implementations of the method and apparatuses described herein, the configuration includes URSP rules for IoT device types associated with the local IoT devices.

### BRIEF DESCRIPTION OF THE DRAWINGS

FIG. 1 illustrates an example of a wireless communications system in accordance with aspects of the present disclosure.

FIG. 2 illustrates an example diagram of an IoT Gateway managing communications between IoT devices and an IoT server in accordance with aspects of the present disclosure.

FIGS. 3A-3B illustrate an example call flow for IoT device integration, interworking, and management in accordance with aspects of the present disclosure.

FIG. 4 illustrates an example of a user equipment (UE) in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by a NE in accordance with aspects of the present disclosure.

FIG. 8 illustrates a flowchart of a method performed by a NE in accordance with aspects of the present disclosure.

### DETAILED DESCRIPTION

Ambient power-enabled devices, such as ambient power-enabled Internet of Things (IoT) devices, include battery-less devices that have limited storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device. Example restricted devices include location tags or stickers, such as tag attached to objects that enable a network server to track locations of the objects. Thus, the network server may be associated with many restricted devices (e.g., hundreds or thousands) for a time period and/or certain deployment.

Such IoT devices may have a low complexity (e.g., low power consumption and few capabilities) to ensure a long life (e.g., 10 plus years) and usefulness. Unlike other IoT devices, such as those defined by 3GPP (3^{rd} Generation Partnership Project), ambient power-enabled devices may not include a USIM (universal subscriber identity module), and thus may lack components that can apply security to communications to/from the devices. Example ambient power-enabled IoT devices may include tags that track items across a supply chain or e-commerce platform.

Further, these ambient IoT devices may include or possess different capabilities with respect to integration in a 5GS. Different ways of authentication with the 5GS (or without the 5GS,) as well as the resulting connectivity provided to such devices, may have implications for the integration, interworking, and/or management of ambient IoT devices. Current solutions, such as aspects of Personal IoT Networks (PIN) may not consider how to integrate and/or manage different device types, when considering their different characteristics.

To solve such issues, a network gateway, or gateway device, can be utilized to integrate and interwork different types of devices with different authentication procedures, which do not allow or provide the devices with default access to a 5GS. For example, ambient IoT devices may not be controlled and managed by 3GPP procedures, even though the authentication would be performed with the 5GS. The network gateway, therefore, may be configured to manage the traffic between the IoT devices device and an IoT Server/Application (e.g., an application function), such as by providing a secure connection and mapping via the gateway.

Thus, in various embodiments, the technology described herein can enable a network gateway, such as an IoT Gateway, to act as a router for mapping and interworking data traffic between local IoT devices (of different device types) and an IoT Server of a 5G network, among other benefits.

Aspects of the present disclosure are described in the context of a wireless communications system.

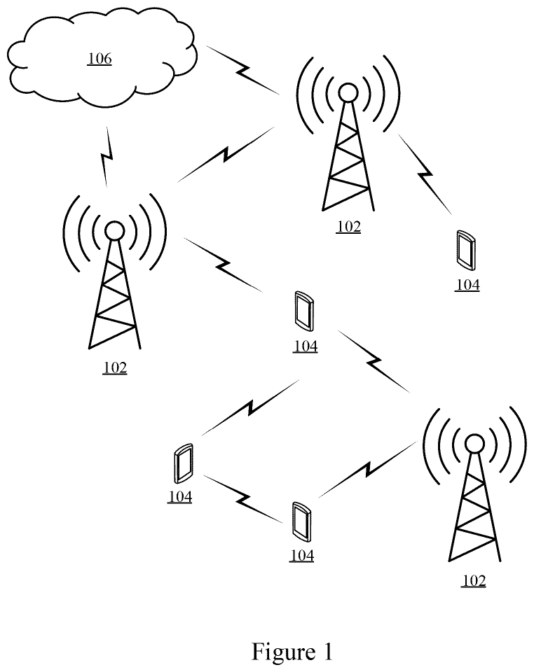

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology enables a network gateway, such as an IoT Gateway, to act as a router for mapping and interworking data traffic between local IoT devices and an IoT Server of a 5G network.

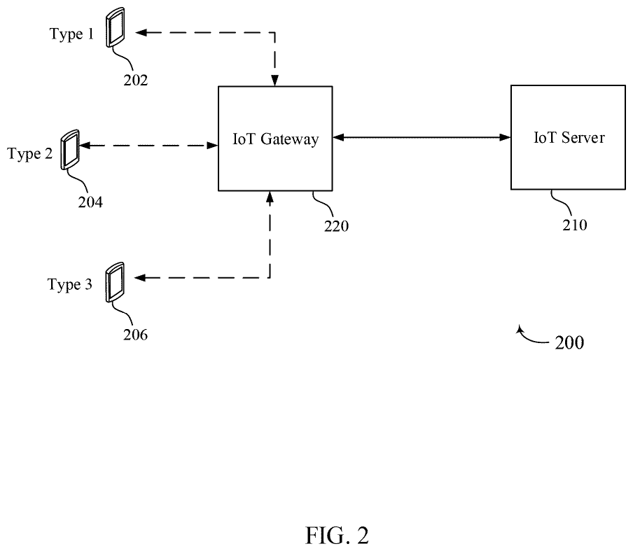

FIG. 2 illustrates an example diagram 200 of an IoT Gateway managing communications between IoT devices and an IoT server in accordance with aspects of the present disclosure. IoT devices 202, 204, 206 of different types may seek access to an IoT Server 210 via an IoT Gateway 220, which maps traffic, based on the types of the IoT devices, to the IoT Server 210. For example, IoT device 202 may be a Type 1 device, IoT device 204 may be a Type 2 device, and IoT device 206 may be a Type 3 device.

The IoT Gateway 220 interworks protocols established for an IoT access network towards the IoT Server 210, or Application Function (AF), and provides a secure connection via an application layer, based on an Authentication and Key Management (AKMA) session establishment. The IoT Gateway 220 is configured by the 5GS to include UE Route Selection Policy (URSP) rules for every IoT Device type (e.g., Types 1, 2, and 3, as described herein). The URSP rues define, for example, how the IoT Gateway 220 maps traffic to a Protocol Data Unit (PDU) Session that carries user plane data to the IoT Server 210.

Table 1 presents various device types for which the IoT Gateway 220 may be configured (although the configuration may include other types not listed in the table):

TABLE 1
device types for IoT devices

| | | | | | Security | | |
|---|---|---|---|---|---|---|---|
| | | | | | Procedure | IoT | |
| Device | | NAS | 5GS | UPF IP | in TS | Gateway | |
| Type | USIM? | Support | Subscription | Connectivity | 33.501 | Role | Comment |
| Type 1 | Yes | No | Yes | Yes | 7A.2.4 | TWIF | Devices that |
| | | | | | | | do not support |
| | | | | | | | 5GC NAS |
| | | | | | | | over WLAN |
| | | | | | | | access, user |
| | | | | | | | plane to UPF |
| Type 2 | Yes | No | Yes | No | S.3.2 | WLAN | NSWO, local |
| | | | | | | AN | IP breakout at |
| | | | | | | | the WLAN |
| | | | | | | | Access |
| | | | | | | | Network |
| Type 3 | No | No | Yes | Yes | 7B.3 | W-AGF | Authentication |
| | | | | | | | for FN-RG |
| | | | | | | | (Fixed |
| | | | | | | | Network |
| | | | | | | | Residential |
| | | | | | | | Gateway); |
| | | | | | | | devices |
| | | | | | | | authenticate |
| | | | | | | | locally and the |
| | | | | | | | W-AGF |
| | | | | | | | registers them |
| | | | | | | | in the 5GS |
| Type 4 | No | No | No | No | None | Gateway | Devices with |
| | | | | | | | local |
| | | | | | | | authentication |
| | | | | | | | at the Gateway |
| | | | | | | | and no 5GS |
| | | | | | | | subscription |

As shown in Table 1, IoT devices of type 1 or type 3 do not have an allowed user plane connection to a user plane function (UPF), but PDU Session Establishment is not described for such devices over non-3GPP access. IoT devices of type 2 or type 4 do not have a user plane connection to the UPF in the 5GS. Thus, the configuration for the IoT Gateway 220 includes a map of local connections to the IoT Gateway 220, according to or based on device type, to the PDU Session of the IoT Gateway 220.

For example, the IoT Gateway 220 registers to the 5GS via a registration request that includes information identifying the types of IoT devices supported by the IoT Gateway 220. When a UDM (Unified Data Management) selects an authentication method, the UDM selects an AKMA indication based on a received IoT indication from an Access and Mobility Management Function (AMF)/Authentication Server Function (AUSF) or based on the IoT indication in an associated subscription profile.

The AUSF performs primary authentication with the IoT Gateway 220, and a Policy Control Function (PCF) provides the URSP rules for mapping the data traffic of the different IoT device types at the time of the PDU Session setup to the IoT Gateway 220. The IoT Gateway 220 performs AKMA session establishment with the IoT Server 210, which is protected with the AKMA credentials or derived from the credentials.

A user plane session of the IoT Gateway 220 with the IoT Server 210 carries the data traffic of the IoT devices 202, 204, 206, mapped according to the URSP rules. For example, once the IoT devices of types 1, 2, or 3 are registered with the 5GS, the IoT Gateway 220 registers the devices to the IoT Sever 210. Similarly, when type 4 devices register locally with the IoT Gateway 220, the IoT Gateway determines whether to register the devices to the IoT Server 210 one by one or in bulk, depending on the number of devices and/or the time window for registration. After registration, the IoT Server 210 may send requests to the IoT Gateway 220, which translates the requests for the IoT devices, depending on or based on the device types of the different IoT devices 202, 204, 206.

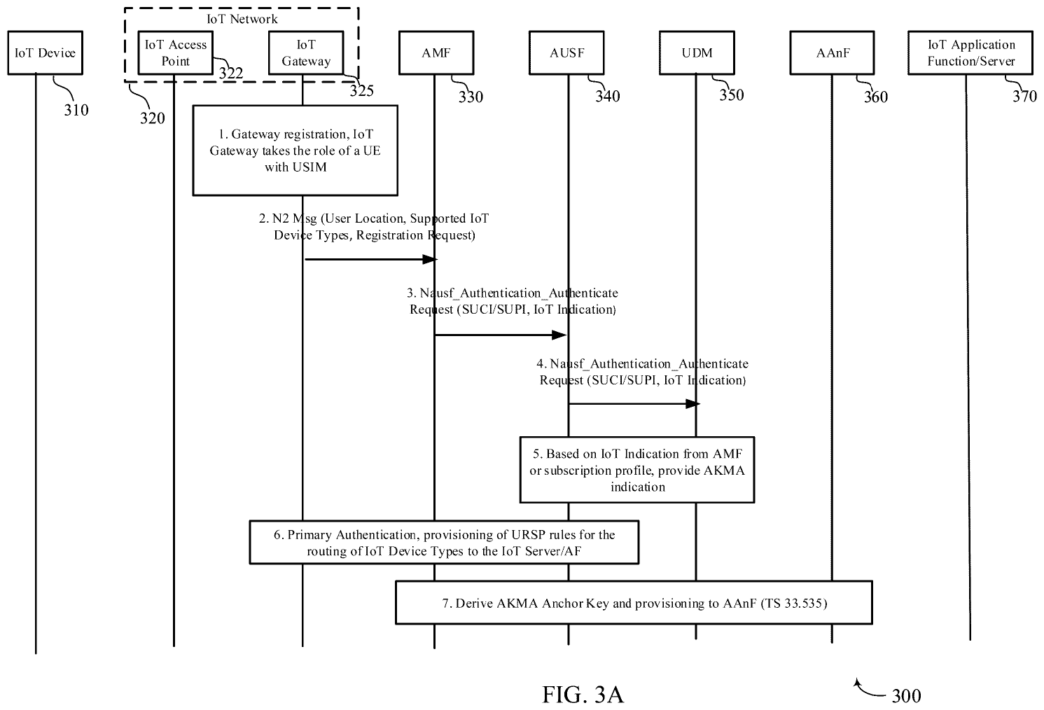

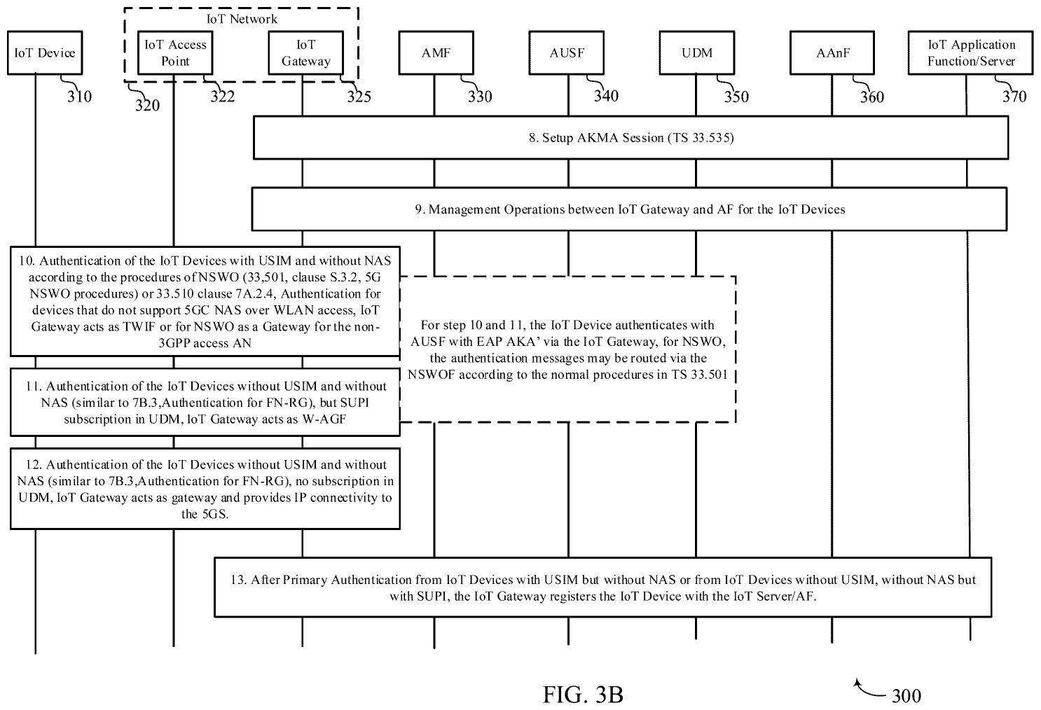

FIGS. 3A-3B illustrate an example call flow 300 for IoT device integration, interworking, and management in accordance with aspects of the present disclosure.

In step 1 (FIG. 3A), an IoT Gateway 325, which is part of an IoT Network 320 that includes an IoT Access Point (AP) 322, registers to a 5GS by sending a Non Access Stratum (NAS) Registration Request to an AMF 330. In doing so, the IoT Gateway 325 assumes the role of a UE with respect to the 5GS, such as by assuming different roles for an IoT device 310, depending on the device type of the IoT device (see Table 1).

In step 2, the IoT Gateway 325 sends the NAS Registration Request to the AMF 330. The request includes the supported device types, and information for each of the types (e.g., different capabilities, such as no USIM, no NAS, and so on, or a common table and index to device type information).

In step 3, the AMF 330 may include an IoT indication when sending an authentication request to an AUSF 340. When the IoT indication is not included, a subscription profile may contain an IoT indication to guide a UDM 350.

In step 4, when the AUSF 340 receives the IoT indication from the AMF 330, the AUSF 340 sends the authentication request with the IoT indication to the UDM 350.

In step 5, the UDM 350 selects an authentication method, and includes an AKMA indication based on the IoT indication (from the authentication request or the subscription profile).

In step 6, the AUSF 340 performs a primary authentication with the IoT gateway 325. At the time of a PDU Session Establishment, a PCF includes URSP rules for mapping traffic of different device types to the PDU Session of the IoT Device 310. For example, the different device types may connect to the IoT Gateway 325 on different port numbers, may have a different application identity, and so on, which are reflected in the URSP rules.

In step 7, the IoT Gateway 325 and the AUSF 340 derive an AKMA Anchor key, and the AUSF 340 provides or provisions the key to an AKMA Anchor Function (AAnF) 360 (e.g., according to TS 33.535).

Moving to FIG. 3B, in step 8, the IoT Gateway 325 establishes an AKMA Session, according to TS 33.535, which is protected with the AKMA Anchor Key or a further derived key. The AKMA Session is a user plane session over the PDU Session that manages the traffic of the IoT Devices (e.g., the IoT device 310) with the URSP rules.

In step 9, the established AKMA session is used for the management operations of an IoT Server 370 (or application function or application server), the IoT Server 370, or AF, may configure the IoT Gateway 325 with events, such as events that cause the IoT Server to receive a notification. For example, a configured event may be when an IoT device of a specific type registers to or via the IoT Gateway 325.

In the following steps 10-12, the call flow is based on the type of device that has registered with the IoT Gateway 325. In step 10, the IoT Device 310 is a type 1 or type 2 device (based on Table 1), and registers to the 5GS. The authentication is based on EAP-AKA′ and carried out with the AUSF 340. The IoT Gateway 325 acts as a Trusted WLAN Interworking Function (TWIF) for any type 1 device and acts as a WLAN access node (AN) for any type 2 device. In some cases, for type 2 devices, the IoT Gateway 325 may also act as a Non-Seamless WLAN Offload Function (NSWOF). The IoT Gateway 325 provides IP connectivity to the UPF/5GS via its PDU Session. In some cases, the IP connectivity may be limited to the user plane session towards the IoT Server 370.

In step 11, the IoT Device 310 is a type 3 device (based on Table 1), and registers to the 5GS via the IoT Gateway 325. The IoT Gateway 325 acts as a Wireline Access Gateway Function (W-AGF) and provides IP connectivity to the UPF/5GS via its PDU Session. In some cases, the IP connectivity may be limited to the user plane session towards the IoT Server 370.

In step 12, the IoT Device 310 is a type 4 device (based on Table 1), and registers locally with the IoT Gateway 325. In some cases, the type 4 device may or may not require IP connectivity, and instead require protocol interworking for further communication with the IoT Server 370. The IoT Gateway acts as a gateway with interworking capabilities and provides IP connectivity to the UPF/5GS via its PDU Session. In some cases, the IP connectivity may be limited to the user plane session towards the IoT Server 370.

In step 13, after primary authentication, the IoT Gateway 325 registers the IoT Device 310 with the IoT Server 370 (or application function). For type 4 device, the IoT Gateway 325 authenticates locally and may register such devices one by one or in bulk to the IoT Server 370. The IoT Gateway 325 maps the traffic from the IoT Device 310 according to the URSP rules to the PDU Session(s) to the IoT Server 370, which is transporting the AKMA user plane session. The IoT Gateway 325 is the local IP gateway for IoT Devices and acts as a router to the 5GS. The IoT Gateway 325 may map/translate the messages from the IoT Server 370 towards the IoT Device 310, and vice versa, and interwork the protocols. In some cases, the security association is hop by hop, such as from the IoT Device 310 to the IoT Gateway 325, and from the IoT Gateway 325 to the IoT Server 370.

Thus, in various embodiments, an IoT Gateway is configured with URSP rules for different device types to map the data traffic from the different devices to a PDU Session that carries a secure user plane connection to an IoT Server for management operations. The secure user plane connection is setup with AKMA procedures. The IoT Gateway acts as a router for mapping and interworking the traffic from the IoT devices towards the IoT Server, and vice versa.

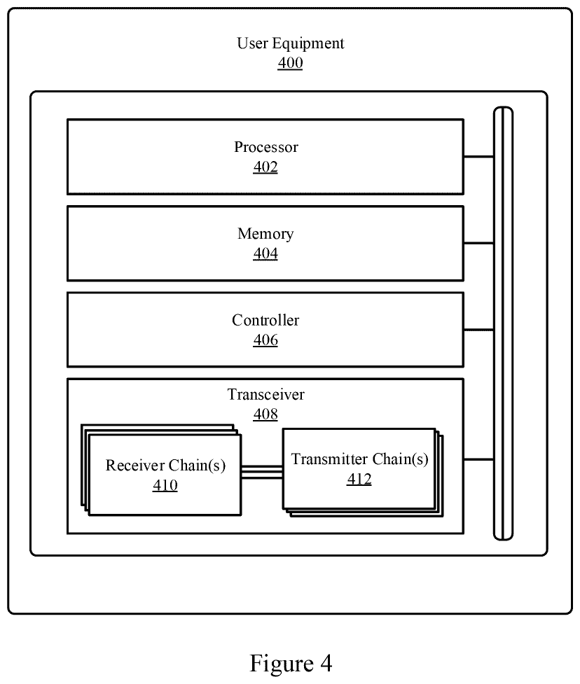

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

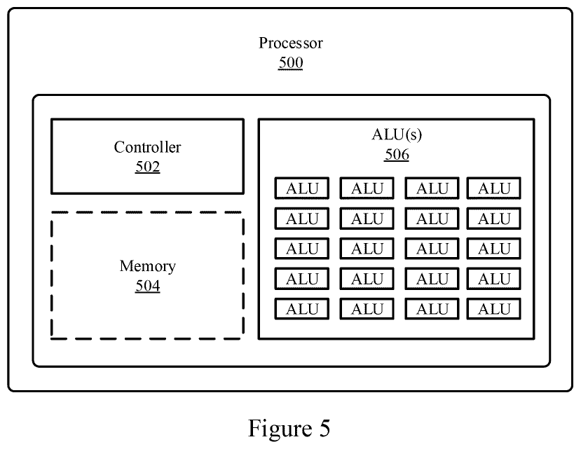

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein.

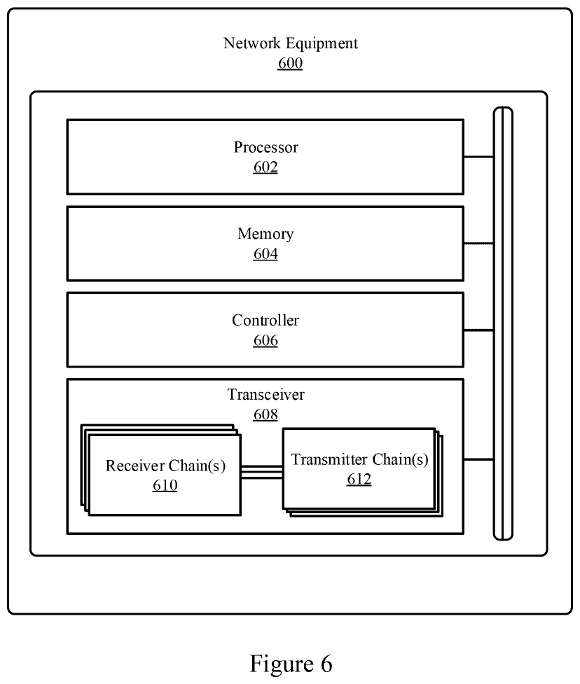

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for receiving, from a first network function, URSP rules for IoT device types associated with IoT devices, wherein the URSP rules configure the network gateway to map data traffic from the IoT devices to an established PDU Session with a second network function, and mapping the data traffic between the IoT devices to a secure user plane session to the second network function based on the URSP rules for the IoT device types of the IoT devices.

Further, the NE 600 may be configured to support a means for receiving a configuration that maps data traffic from local IoT devices to an established PDU Session with an IoT Server and mapping the data traffic between the local IoT devices to a secure user plane session to the IoT Server based on the configuration.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

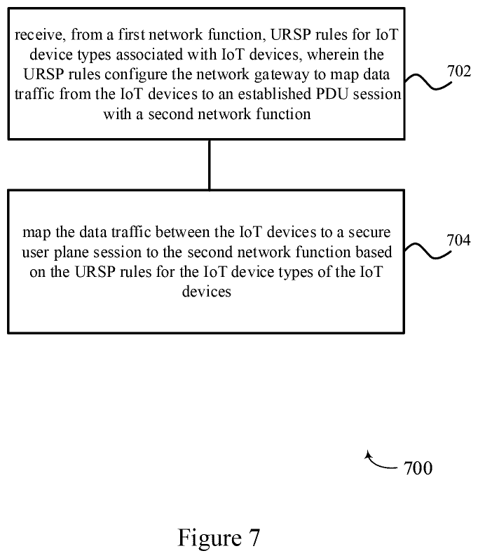

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions.

At 702, the method may include receiving, from a first network function, URSP rules for IoT device types associated with IoT devices, wherein the URSP rules configure the network gateway to map data traffic from the IoT devices to an established PDU Session with a second network function. The operations of 702 may be performed in accordance with examples as described herein. In some implementations, aspects of the operations of 702 may be performed by a NE as described with reference to FIG. 6.

At 704, the method may include mapping the data traffic between the IoT devices to a secure user plane session to the second network function based on the URSP rules for the IoT device types of the IoT devices. The operations of 704 may be performed in accordance with examples as described herein. In some implementations, aspects of the operations of 704 may be performed by a NE as described with reference to FIG. 6.

It should be noted that the method described herein describes a possible implementation, and that the operations and the steps may be rearranged or otherwise modified and that other implementations are possible.

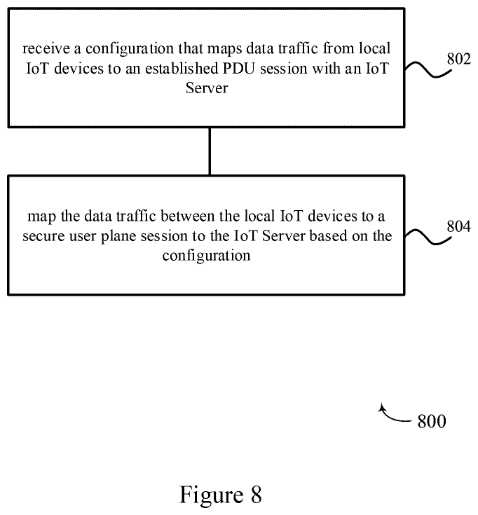

FIG. 8 illustrates a flowchart of a method 800 in accordance with aspects of the present disclosure. The operations of the method may be implemented by a NE as described herein. In some implementations, the NE may execute a set of instructions to control the function elements of the NE to perform the described functions.

At 802, the method may include receiving a configuration that maps data traffic from local IoT devices to an established PDU Session with an IoT Server. The operations of 802 may be performed in accordance with examples as described herein. In some implementations, aspects of the operations of 802 may be performed by a NE as described with reference to FIG. 6.

At 804, the method may include mapping the data traffic between the local IoT devices to a secure user plane session to the IoT Server based on the configuration. The operations of 804 may be performed in accordance with examples as described herein. In some implementations, aspects of the operations of 804 may be performed by a NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network gateway for wireless communication, comprising:
at least one memory; and
at least one processor coupled with the at least one memory and configured to cause the network gateway to:
receive, from a first network function, User Equipment Route Selection Policy (URSP) rules for internet of things (IoT) device types associated with IoT devices,
wherein the URSP rules configure the network gateway to map data traffic from the IoT devices to an established protocol data unit (PDU) session with a second network function; and
map the data traffic between the IoT devices to a secure user plane session to the second network function based on the URSP rules for the IoT device types of the IoT devices.

2. The network gateway of claim 1, wherein the first network function is a Policy Control Function (PCF) and the second network function is an IoT Server or Application Function (AF).

3. The network gateway of claim 1, wherein the at least one processor is further configured to cause the network gateway to:
send, to a third network function, a registration request that indicates capabilities of IoT device types supported by the network gateway.

4. The network gateway of claim 3, wherein the third network function is an Access and Mobility Management Function (AMF).

5. The network gateway of claim 3, wherein the capabilities of IoT device types indicated by the registration request include whether an IoT device includes a universal subscriber identity module (USIM) or whether an IoT device includes Non Access Stratum (NAS) support.

6. The network gateway of claim 1, wherein the at least one processor is further configured to cause the network gateway to:
establish the secure user plane session over the established PDU Session with the second network function.

7. The network gateway of claim 1, wherein the at least one processor is further configured to cause the network gateway to:
receive configuration messages from the second network function over the secure user plane connection.

8. The network gateway of claim 1, wherein the at least one processor is further configured to cause the network gateway to:
authenticate the IoT devices via a fourth network function; and
register the IoT devices at the second network function after a successful authentication.

9. The network gateway of claim 8, wherein the fourth network function is an Authentication Server Function (AUSF).

10. The network gateway of claim 1, wherein the network gateway acts as a Trusted WLAN Interworking Function (TWIF) for a first subset of IoT devices, a WLAN access node (AN) for a second subset of IoT devices, a Wireline Access Gateway Function (W-AGF) for a third subset of IoT devices, and a gateway with interworking capabilities for a fourth subset of IoT devices.

11. A method performed by a network gateway, the method comprising:
receiving, from a first network function, User Equipment Route Selection Policy (URSP) rules for internet of things (IoT) device types associated with IoT devices,
wherein the URSP rules configure the network gateway to map data traffic from the IoT devices to an established protocol data unit (PDU) session with a second network function; and
mapping the data traffic between the IoT devices to a secure user plane session to the second network function based on the URSP rules for the IoT device types of the IoT devices.

12. The method of claim 11, further comprising:
sending, to a third network function, a registration request that indicates capabilities of IoT device types supported by the network gateway.

13. The method of claim 11, further comprising:
establishing the secure user plane session over the established PDU Session with the second network function.

14. The method of claim 11, further comprising:
authenticating the IoT devices via a fourth network function; and
registering the IoT devices at the second network function after a successful authentication.

15. A network gateway for wireless communication, comprising:
at least one memory; and
at least one processor coupled with the at least one memory and configured to cause the network gateway to:
receive a configuration that maps data traffic from local internet of things (IoT) devices to an established protocol data unit (PDU) session with an IoT Server; and
map the data traffic between the local IoT devices to a secure user plane session to the IoT Server based on the configuration.

16. The network gateway of claim 15, wherein the configuration includes User Equipment Route Selection Policy (URSP) rules for internet of things (IoT) device types associated with the local IoT devices.

17. The network gateway of claim 15, wherein the network gateway receives the configuration from a Policy Control Function (PCF).

18. The network gateway of claim 15, wherein the local IoT devices are ambient IoT devices, and wherein the network gateway is an IoT Gateway via which the ambient IoT devices access a 5G network.

19. A method performed by a network gateway, the method comprising:
receiving a configuration that maps data traffic from local internet of things (IoT) devices to an established protocol data unit (PDU) session with an IoT Server; and
mapping the data traffic between the local IoT devices to a secure user plane session to the IoT Server based on the configuration.

20. The method of claim 19, wherein the configuration includes User Equipment Route Selection Policy (URSP) rules for internet of things (IoT) device types associated with the local IoT devices.
